(19) United States
(12) Patent Application Publication
(10) Pub. No.: US 2026/0021460 A1
(43) Pub. Date: Jan. 22, 2026

(54) Mixer Adapter for a Two-Component Composition Cartridge, and Mixer-Cartridge Assembly Equipped with the Same

(71) Applicant: Henkel AG & Co. KGaA, Düsseldorf (DE)

(72) Inventors: ZhongHua Zhang, Shanghai-Zhangjiang (CN); ChengYu Wang, Shanghai-Zhangjiang (CN); Ji Feng, Shanghai-Zhangjiang (CN); ZheCheng Dong, Shanghai (CN)

(21) Appl. No.: 19/341,117

(22) Filed: Sep. 26, 2025

Related U.S. Application Data
(63) Continuation of application No. PCT/CN2023/084818, filed on Mar. 29, 2023.

(51) Int. Cl. B01F 25/46; B01F 33/501; B01F 101/36

(52) U.S. Cl. CPC B01F 25/46; B01F 33/50112; B01F 2101/36

(57) ABSTRACT

The present disclosure generally relates to a mixer adapter (100) for a two-component composition cartridge, comprising: a connector member (10) formed with a first channel (14) and a separate second channel (15), the connector member (10) including a base (11), a middle part (12) extending longitudinally from the base (11), and a head (13) extending longitudinally from the middle part (12), a rotatable fastening member (20), the base (11) being configured to be releasably connected to the rotatable fastening member (20) via an open circlip (30), the head (13) is formed with a planar end face (13A) and the base (11) is formed with a planar end face (11D) such that the first and second channels (14 and 15) extend between the two planar end faces (13A, 11D); and a first sleeve (16) and a second sleeve (17) installed into the base (11) and in fluid communication with the first channel (14) and the second channel (15) respectively, wherein the first sleeve (16) and the second sleeve (17) are configured to partially protrude from the planar end face (11D) of the base (11) in a hollow space of the rotatable fastening member (20). The present disclosure also relates to a mixer-cartridge assembly.

### FIELD

The present disclosure generally relates to a mixer adapter for a two-component composition cartridge, and a mixer-cartridge assembly equipped with said adapter

### BACKGROUND

In many engineering fields, fluid dispensing systems used to mix two fluid components to form a desired mixture are required. Especially, in bonding fields, an adhesive dispensing system for applying a mixture of two adhesive precursors plays an important role. Such an adhesive dispensing system usually comprises a two-component composition adhesive cartridge and a mixer. The two-component composition adhesive cartridge is provided with two cartridges for storing two different adhesive precursors therein before they are discharged. The two-component composition adhesive cartridge is also provided with a port configured to communicate with both of the two cartridges. The two-component composition adhesive cartridge is configured to cooperate with the mixer, via the port, through which mixer the two different adhesive precursors in a flowable state will be mixed and thereafter dispensed via the adhesive dispensing system.

According to various dispensing requirements (such as speed, pressure, or the like) and various compositions of the adhesive components, the adhesive dispensing system has to be equipped with different-type mixers and different-type cartridges. That is, in the prior art, one-type mixer can be used to cooperate with one-type two-component composition adhesive cartridge relevant to the mixer only. This will require that customers have to prepare different-type mixers for different-type two-component composition adhesive cartridges, resulting in increased costs to use. Therefore, it is desirable to develop a mixer adaptor such that one-type two-component composition adhesive cartridge can be readily and quickly switchable between a state, in which it can cooperate with one of two-type mixers, and a state, in which it can cooperate with the other of two-type mixers. It is also desirable that the developed mixer adapter shall be easily cleanable so as to avoid moisture curing of adhesive precursors left thereon when the mixer adapter has been used for several two-component composition adhesive cartridges of the same type.

### SUMMARY

It is an object of the present disclosure to propose a novel mixer adapter which can be conveniently attached to a special-type two-component composition adhesive cartridge such that the two-component composition adhesive cartridge will be enabled to cooperate with a mixer for another special-type dual component adhesive cartridge.

According to an aspect, the present disclosure proposes a mixer adapter for a two-component composition cartridge, comprising:
a connector member formed with a first channel and a separate second channel, the connector member including a base, a middle part extending longitudinally from the base, and a head extending longitudinally from the middle part,
a rotatable fastening member, the base being configured to be releasably connected to the rotatable fastening member via an open circlip, the head is formed with a planar end face and the base is formed with a planar end face such that the first and second channels extend between the two planar end faces; and
a first sleeve and a second sleeve installed into the base and in fluid communication with the first channel and the second channel respectively, wherein the first sleeve and the second sleeve are configured to partially protrude from the planar end face of the base in a hollow space of the rotatable fastening member.

In an embodiment, each of the first sleeve and the second sleeve is provided with an exposed end chamfered with a conical bevel surface.

In an embodiment, a partition is formed on the planar face of the head between the first sleeve and the second sleeve.

In an embodiment, the partition is substantially triangular.

In an embodiment, the connector member comprises a poka-yoke feature such that the exposed ends of the first and second sleeves can be only inserted into an object in a specified orientation.

In an embodiment, the connector member is made of a metal material such as stainless steel.

In an embodiment, the middle part is formed with outer threads on its outer surface.

In an embodiment, the base includes a first section and a second section which is of an outer contour bigger than the first section.

In an embodiment, the rotatable fastening member includes an annular inner edge extending inwards from an inner wall of the rotatable fastening member, and the second section is located in the hollow space of the rotatable fastening member.

In an embodiment, an annular groove is formed in an outer surface of the first section to receive the open circlip such that the annular inner edge can be longitudinally clamped between the open circlip and the second section.

In an embodiment, the rotatable fastening member comprises two wings which are axially opposite to the annular inner edge to define a non-circular opening.

In an embodiment, the partition is vertical relative to the planar face of the head.

In an embodiment, the two-component composition cartridge is a two-component composition adhesive cartridge comprising two cartridges for holding different liquid adhesive precursors therein and a port in fluid communication with the two cartridges, the mixer adapter can be inserted into the port via the exposed ends of the first and second sleeves.

According to another aspect, the present disclosure proposes a mixer-cartridge assembly, comprising:
a mixer;
a two-component composition cartridge including two cartridges for holding different liquid precursors therein and a port in fluid communication with the two cartridges; and
said mixer adapter mentioned above, wherein the mixer is releasably coupled to a head of the mixer adapter and a base of the mixer adapter is releasably coupled to the two-component composition cartridge by inserting exposed ends of a first sleeve (16) and a second sleeve (17) of the mixer adapter (100), such that the mixer can be in fluid communication with the two cartridges.

In an embodiment, the mixer is provided with a cap and a tube in fluid communication with the cap, when the mixer is coupled to the head, the cap is sleeved onto the head, and a partition of the mixer adapter is housed in the cap.

Using the technical measures mentioned here, the mixer adapter can be readily cleaned after a long-term usage. In this way, moisture curing of two different residual liquids can be avoided. Besides, when assembled, the mixer adapter can avoid premature curing of the two different liquids when discharged and improve the pot life of the adhesive. Besides, the poka-yoke feature design can facilitate correcting any action mistake of a user such that the mixer adapter can be always coupled to the two-component composition cartridge in the specified orientation. Finally, the mixer adapter according to the present disclosure allows an improved sealing interface formed between it and the coupled two-component composition cartridge.

### BRIEF DESCRIPTION OF THE DRAWINGS

The principles and the other aspects of the present disclosure will be explained in the following description with reference to the drawings. In the drawings of the present disclosure, the features having the same configuration or same functions may be represented by the same reference numerals respectively.

FIG. 1A is a block diagram schematically illustrating a dispensing system equipped with a first-type mixer, a first-type two-component composition adhesive cartridge coupled to the first-type mixer, and a pump device;

FIG. 1B is a block diagram schematically illustrating a dispensing system equipped with a second-type mixer, a second-type two-component composition adhesive cartridge coupled to the second-type mixer, and a pump device;

FIG. 1C is a block diagram schematically illustrating a dispensing system equipped with a second-type mixer, a first-type two-component composition adhesive cartridge coupled to the second-type mixer via a mixer adapter according to the present disclosure, and a pump device;

FIG. 2 is a perspective view schematically illustrating a mixer adapter according to an embodiment of the present disclosure;

FIG. 3 is a perspective view schematically illustrating the mixer adapter of FIG. 2 observed in a direction different than FIG. 2;

FIG. 4 is an axial section view schematically illustrating the mixer adapter of FIG. 2;

FIG. 5 is a partial perspective view schematically illustrating a part of a two-component composition adhesive cartridge and a connecting port (for example a F-type connecting port) of the two-component composition adhesive cartridge, wherein the connecting port is specialized for one existing-type (for example a F-type) mixer;

FIG. 6 is a partial perspective view of the connecting port of the two-component composition cartridge of FIG. 5;

FIG. 7 is a front view schematically illustrating the mixier adapter of FIG. 2 that has been fitted onto the connecting port of FIG. 5 and has been connected to a part of another existing-type (for example a C-type) mixer;

FIG. 8 is a section view schematically illustrating the mixier adapter that has been fitted onto the connecting port of FIG. 5 and has been connected to the part of said another existing-type (for example the C-type) mixer.

### DETAILED DESCRIPTION OF EMBODIMENTS

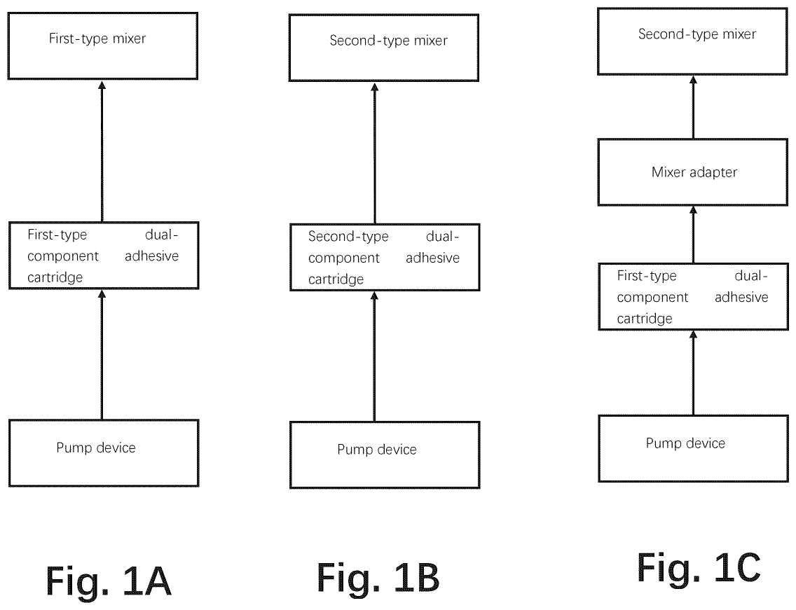

FIG. 1A schematically shows a dispensing system according to the prior art for dispensing an adhesive mixed by two adhesive precursors. The dispensing system generally comprises a first-type mixer, a first-type two-component composition adhesive cartridge coupled to the first-type mixer, and a pump device. The first-type two-component composition adhesive cartridge comprises two cartridges for separately storing two different adhesive precursors therein and a first-type port which is in fluid communication with both of the two cartridges. The first-type mixer is designed to be coupled only to the first-type port. The pump device is configured to selectively feed the two different adhesive precursors separately through the respective cartridges such that the two different adhesive precursors can pass the first-type port and be mixed in the first-type mixer coupled to the first-type port. Thereafter, the mixed adhesive can be applied by a nozzle (not shown) of the dispensing system.

FIG. 1B schematically shows a dispensing system according to the prior art for dispensing an adhesive mixed by two adhesive precursors. The dispensing system generally comprises a first-type mixer, a second-type two-component composition adhesive cartridge coupled to the second-type mixer, and a pump device. The second-type two-component composition adhesive cartridge comprises two cartridges for separately storing two different adhesive precursors therein and a second-type port which is in fluid communication with both of the two cartridges. The second-type mixer is designed to be coupled only to the second-type port. The pump device is configured to selectively feed the two different adhesive precursors separately through the respective cartridges such that the two different adhesive precursors can pass the second-type port and be mixed in the second-type mixer coupled to the second-type port. Thereafter, the mixed adhesive can be applied by a nozzle (not shown) of the dispensing system.

According to the prior art, the first-type mixer and the second-type mixer are designed completely different than each other, and the first-type port and the second-type port are also designed completely different than each other.

FIG. 1C schematically shows a dispensing system according to the present disclosure for dispensing an adhesive mixed by two adhesive precursors. The dispensing system generally comprises the second-type mixer, the first-type two-component composition adhesive cartridge, and a pump device. As mentioned above, since the second-type mixer is not compatible with the first-type two-component composition adhesive cartridge, the second-type mixer cannot be coupled directly to the first-type port of the two-component composition adhesive cartridge. However, according to the present disclosure, a mixer adapter 100 explained below will enable the second-type mixer to be coupled to the first-type port of the two-component composition adhesive cartridge.

In the context of the present disclosure, as an example, the first-type port of the two-component composition adhesive cartridge and the first-type mixer can be a F-type two-component composition adhesive cartridge and a F-type mixer respectively available in the market, and the second-type port of the two-component composition adhesive cartridge and the second-type mixer can be a C-type two-component composition adhesive cartridge and a C-type mixer respectively available in the market.

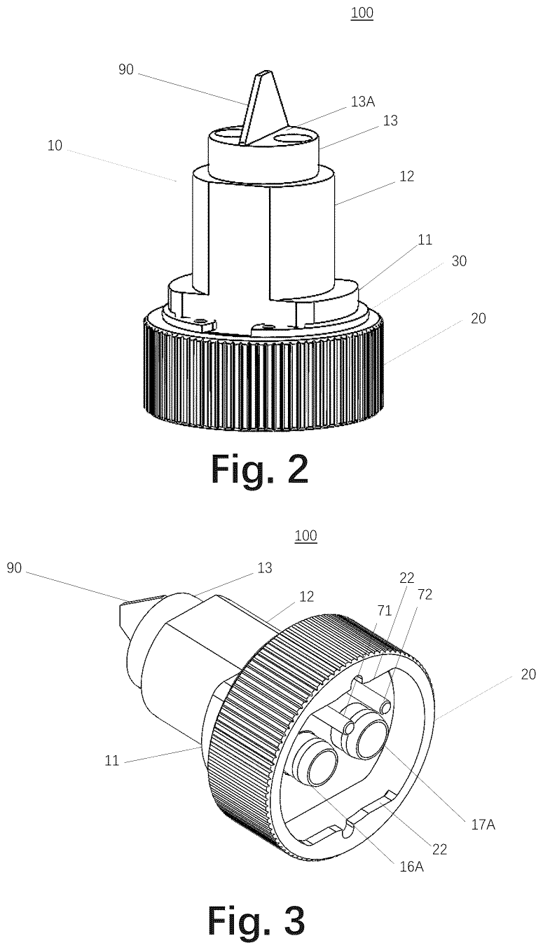

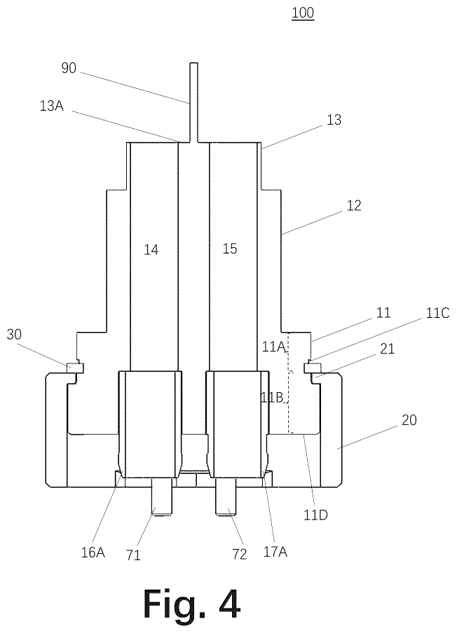

As shown by FIGS. 2 and 3, the mixer adapter 100 according to an embodiment of the present disclosure generally comprises a connector member 10, and a rotatable fastening member 20 releasably coupled to the connector member 10. Both the connector member 10 and the rotatable fastening member 20 are made of a metal material such as stainless steel. The connector member 10 is provided with a base 11 (as shown by FIG. 4), a middle part 12 extending longitudinally from the base 11, and a head 13 extending longitudinally from the middle part 12. The head 13 is configured to have an outer contour smaller than the middle part 12, and the middle part 12 is configured to have an outer contour smaller than the base 11. There is a step formed between the head 13 and the middle part 12. The head 13 is in the form of a cylinder. The head 13 is provided with a planar end face 13A which is longitudinally opposite to the step. The middle part 12 is formed with outer threads on its outer surface (at least on a part of the outer surface adjacent to the head 13). The middle part 12 is also in the form of a cylinder. The head 13 and the middle part 12 are sized in a manner substantially mating with an existing C-type mixer. That is to say, the head 13 and the middle part 12 are configured such that the existing C-type mixer can be releasably fitted onto them.

The base 11 is configured to include two sections 11A and 11B. There is a step formed between the middle part 12 and the section 11A. The section 11B is of an outer contour bigger than the section 11A. The rotatable fastening member 20 is in the form of a short hollow cylinder. The section 11B is located in a hollow space of the rotatable fastening member 20. Therefore, the rotatable fastening member 20 has an inner diameter greater than the connector member 10. However, the rotatable fastening member 20 has an annular inner edge 21 which extends inwards from an inner wall of the rotatable fastening member 20. The annular inner edge 21 defines an opening's diameter less than the outer contour of the section 11B of the base 11 and greater than the outer contours of the head 13, the middle part 12, and the section 11A. In this way, when assembling the mixer adapter 100, the rotatable fastening member 20 can be sleeved from the head 13, through the middle part 12, onto the base 11. Due to the existence of the annular inner edge 21, the rotatable fastening member 20 is stopped by the section 11B. In the section 11A, there is an annular groove 11C formed in an outer surface longitudinally adjacent to the section 11B. This annular groove 11C is configured to receive an open circlip 30 therein. Viewed in a cross-section perpendicular to a longitudinal axis of the connector member 10, the circlip 30 has an opening such that the circlip 30 can be received in the annular groove 11C by enlarging the opening of the circlip 30. The circlip 30 is configured such that when it is received in the annular groove 11C, the annular inner edge 21 can be clamped longitudinally between the circlip 30 and the section 11B of the base 11. However, in this case, the rotatable fastening member 20 is still freely rotatable about a central axis of the connector member 10.

In the connector member 10, two separate channels 14 and 15 are formed such that two different adhesive precursors can be conveyed through the channels 14 and 15 respectively. The section 11B of the base 11 has a planar end face 11D within the hollow space of the rotatable fastening member 20. The planar end face 13A is longitudinally opposite to the planar end face 11D. The mixer adapter 100 is also provided with two sleeves 16 and 17. For example, the sleeve 16 can be inserted into a hole formed in the base 11 in fluid communication with the channel 14, and the sleeve 17 can be inserted into a hole formed in the base 11 in fluid communication with the channel 15. Due to the difference between two different-type two-component composition adhesive cartridges, inner diameters of the channels 14 and 15 are different than inner diameters of the sleeves 16 and 17. The inner diameters of the sleeves 16 and 17 are greater than those of the channels 14 and 15. Each of the sleeves 16 and 17 is configured to have an exposed end protruding from the planar end face 11D. The exposed end 16A of the sleeve 16 and the exposed end 17A of the sleeve 17 are each chamfered with a conical bevel surface.

For example, the sleeves 16 and 17 can be bonded securely in the respective holes. In an alternative embodiment, the sleeves 16 and 17 can be screwed securely in the respective holes.

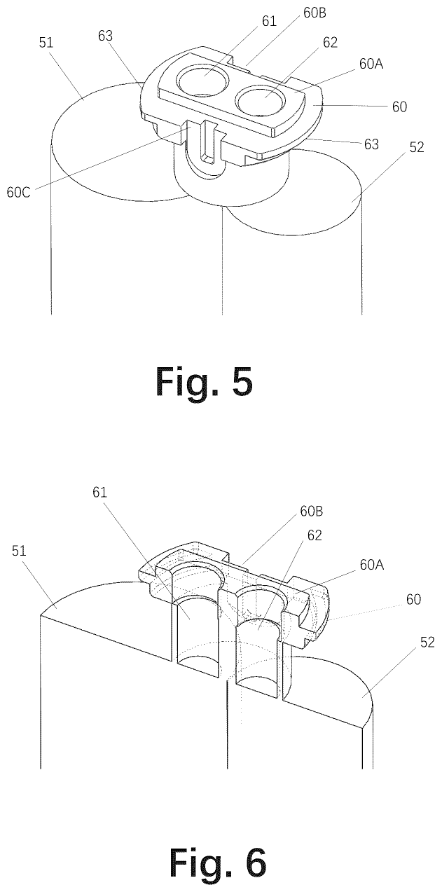

FIG. 5 shows a part of a two-component composition adhesive cartridge. For instance, it can be a F-type two-component composition adhesive cartridge according to the prior art provided with two cylinders 51, 52 for separately holding two different adhesive precursors therein, and a F-type port 60 in fluid communication with the two cylinders 51, 52. The port 60 is provided with a planar end face 60A, and two separate passages 61 and 62. For instance, as shown by FIG. 6, the port 60 can be fitted to both the two cylinders 51, 52 such that the passages 61 and 62 are in fluid communication with the interiors of the cylinders 51, 52 respectively. Additionally, the port 60 is formed with two notches 60B and 60C which opposes each other. The notch 60B is bigger than the notch 60C.

As shown by FIG. 4, the rotatable fastening member 20 is formed with a non-circular opening in an end longitudinally opposite to the annular inner edge 21. For example, the non-circular opening of the rotatable fastening member 20 is slightly greater than the outer contour of the port 60 such that the port 60 can pass the non-circular opening. In an embodiment, the non-circular opening of the rotatable fastening member 20 is defined by two opposite wings 22 which configured to extend radially inwards from the end's edge by a distance respectively. The port 60 is made of a softer material, for example a plastic material. The sleeves 16 and 17 are made of the same material as the connector member 10. The sleeves 16 and 17 are formed such that the outer diameters of them are slightly greater than the inner diameters of the passages 61 and 62 respectively. In this way, the sleeves 16 and 17 can be inserted and held respectively in the passages 61 and 62 in an interference fit manner. As shown by FIG. 6, each of the passages 61 and 62 is formed with a step. Therefore, when the exposed end 16A of the sleeve 16 is inserted into the passage 61, the conical bevel surface of the sleeve 16 can be compressed by the step of the passage 61 and thus an improved sealing interface can be suitably generated between them. Similarly, when the exposed end 17A of the sleeve 17 is inserted into the passage 62, the conical bevel surface of the sleeve 17 can be compressed by the step of the passage 62 and thus an improved sealing interface can be suitably generated between them. As the sleeves 16 and 17 have been inserted respectively in the passages 61 and 62 in place and thus the respective sealing interfaces have been generated suitably, the end face 60A of the port 60 is in contact with the end face 11D of the connector member 10 and the rotatable fastening member 20 surrounds them. Therefore, the rotatable fastening member 20 can protect the contact interface from any foreign substance.

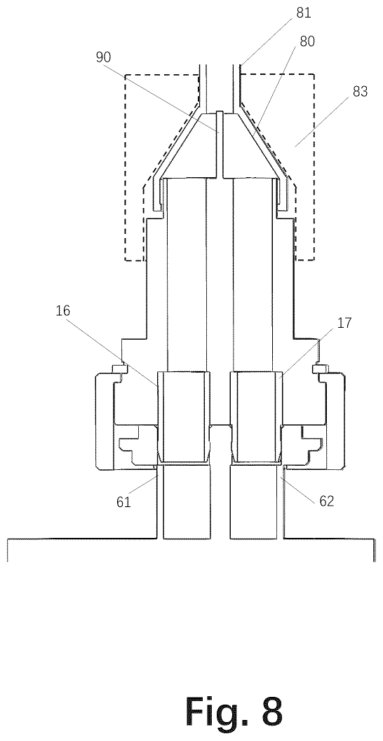

In most cases, the port 60 shall be coupled to the mixer adapter 100 in a specified orientation such that the sleeve 16 is always inserted into the passage 61 and the sleeve 17 is always inserted into the passage 62, as shown by FIG. 8. Therefore, the mixer adapter 100 is provided with a poka-yoke feature. In an embodiment, the poka-yoke feature comprises two pins 71 and 72 which are spaced from each other. For example, the two pins 71 and 72 can be welded on, screwed into, bonded onto the end face 11D of the connector member 10 such that at least a part of them can protrude from the end face 11D of the connector member 10. The pins 71 and 72 are spaced from each other by a distance which is greater than a width of the notch 60C and less than a width of the notch 60B. Viewed in a cross-section of the port 60 perpendicular to the axis of the passages 60B and 60C, the notches 60B and 60C are T-shaped and therefore, the width of the notches 60B and 60C mentioned here is measured in a direction parallel to the cross beam of T. Therefore, the pins 71 and 72 can be received only in the notch 60B rather than the notch 60C. The pins 71 and 72 are configured such that when the sleeves 16 and 17 are suitably inserted and hold in the passages 61 and 62 respectively, the pins 71 and 72 are received in the notch 60B. This will ensure that the mixer adapter 100 can be coupled to the port 60 in the specified orientation. In the port 60, two opposite arc-shaped edges 63 are formed. The arc-shaped edges 63 of the port 60 and the wings 22 of the rotatable fastening member 20 are configured such that when they are not aligned with each other (for example, in the illustrated example, when they are substantially at a right angle), the pins 71 and 72 are allowed to be received into the notch 60B and thus the sleeves 16 and 17 are allowed to be inserted into the passages 61 and 62 respectively, Thereafter, by rotating the rotatable fastening member 20 such that the wings 22 are aligned with the edge 63 and clamped under the edges 63 respectively, the rotatable fastening member 20 can be held axially immovable relative to the port 60.

In an alternative embodiment, the two pins 71 and 72 can be replaced with a single metal plate secured (welded or bonded) on the end face 11D. The metal place has a width similar to the distance between the two pins 71 and 72.

As the connector member 10 and the rotatable fastening member 20 are made of stainless and can be readily releasably fitted with each other via the open circlip 30, it is convenient to disassemble and clean the mixer adapter 100 after a long-term usage, such that moisture curing of residual adhesive precursors can be effectively avoided. The mixer adapter 100 according to the present disclosure is easy to clean and reusable for many times.

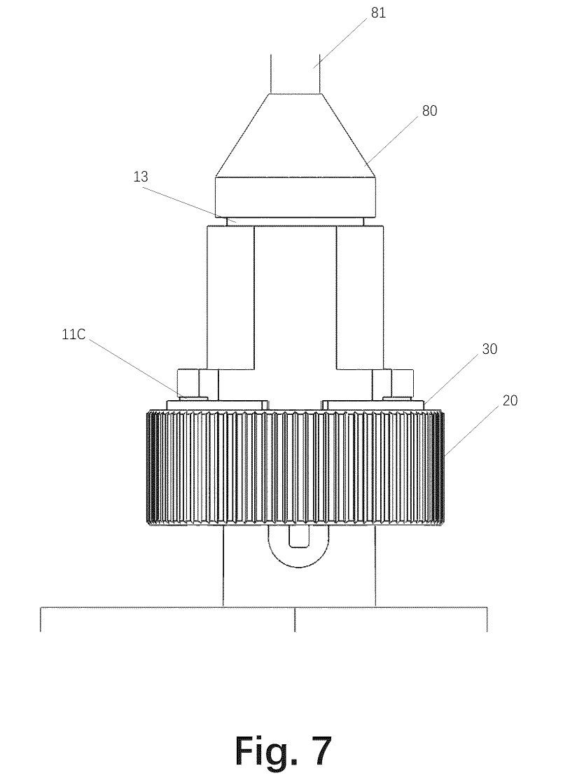

As shown by FIGS. 7 and 8, when or before the mixer adapter 100 is coupled to the port 60, a conical cap 80 can be sleeved onto the head 13. In the illustrated embodiment, the cap 80 can be a part of the existing C-type mixer. The cap 80 is provided on an end of a tube 81 of the existing C-type mixer. A rotatable knob part 83 is slidably sleeved on the tube 81 and the knob part 83 is formed with inner threads which can engage with the outer threads formed on the outer surface of the middle part 12.

Therefore, after the cap 80 is sleeved on the head 13, the knob part 83 can be forced to engage with the middle part 12 such that the cap 80 can be securely clamped between the head 13 and the knob part 83.

In an embodiment, a partition 90 is vertically formed on the end face 13A between the channels 14 and 15. As shown by FIG. 8, the partition 90 is configured to separate the flowable adhesive precursors before they enter the tube 81 of the mixer. In this way, premature curing of the adhesive can be eliminated and the pot life of the adhesive can be improved. In the illustrated embodiment, the partition 90 is triangle. In an alternative embodiment, the partition 90 can be rectangular, square, or other suitably-shaped.

Although the embodiments of the present disclosure are described with respect to the two-component composition adhesive cartridge, it is understood by a person skilled in the art that they also apply to other two-component composition cartridges. Although some specific embodiments and/or examples of the present disclosure are described here, they are given for illustrative purposes only and cannot be deemed to constrain the scope of the present disclosure in any way. Furthermore, it should be understood by a skilled person in the art that the embodiments and/or examples described here can be combined with each other. Without departing from the spirit and scope of the present disclosure, various replacements, modifications, and alternations can be carried out.

1. A mixer adapter (100) for a two-component composition cartridge, comprising:
a connector member (10) formed with a first channel (14) and a separate second channel (15), the connector member (10) including a base (11), a middle part (12) extending longitudinally from the base (11), and a head (13) extending longitudinally from the middle part (12),
a rotatable fastening member (20), the base (11) being configured to be releasably connected to the rotatable fastening member (20) via an open circlip (30), the head (13) is formed with a planar end face (13A) and the base (11) is formed with a planar end face (11D) such that the first and second channels (14 and 15) extend between the two planar end faces (13A, 11D); and
a first sleeve (16) and a second sleeve (17) installed into the base (11) and in fluid communication with the first channel (14) and the second channel (15) respectively, wherein the first sleeve (16) and the second sleeve (17) are configured to partially protrude from the planar end face (11D) of the base (11) in a hollow space of the rotatable fastening member (20).

2. The mixer adapter (100) according to claim 1, wherein each of the first sleeve (16) and the second sleeve (17) is provided with an exposed end (16A or 17A) chamfered with a conical bevel surface.

3. The mixer adapter (100) according to claim 1, wherein a partition (90) is formed on the planar face (13A) of the head (13) between the first sleeve (16) and the second sleeve (17).

4. The mixer adapter (100) according to claim 3, wherein the partition (90) is substantially triangular.

5. The mixer adapter (100) according to claim 4, wherein the connector member (10) comprises a poka-yoke feature such that the exposed ends (16A and 17A) of the first and second sleeves (16 and 17) can be only inserted into an object in a specified orientation.

6. The mixer adapter (100) according to claim 5, wherein the middle part (12) is formed with outer threads on its outer surface.

7. The mixer adapter (100) according to claim 6, wherein the base (11) includes a first section (11A) and a second section (11B) which is of an outer contour bigger than the first section (11A).

8. The mixer adapter (100) according to claim 7, wherein the rotatable fastening member (20) includes an annular inner edge (21) extending inwards from an inner wall of the rotatable fastening member (20), and the second section (11B) is located in the hollow space of the rotatable fastening member (20).

9. The mixer adapter (100) according to claim 8, wherein an annular groove (11C) is formed in an outer surface of the first section (11A) to receive the open circlip (30) such that the annular inner edge (21) can be longitudinally clamped between the open circlip (30) and the second section (11B).

10. The mixer adapter (100) according to claim 9, wherein the rotatable fastening member (20) comprises two wings (22) which are axially opposite to the annular inner edge (21) to define a non-circular opening.

11. The mixer adapter (100) according to claim 10, wherein the partition (90) is vertical relative to the planar face (13A) of the head (13).

12. The mixer adapter (100) according to claim 1, wherein the two-component composition cartridge is a two-component composition adhesive cartridge comprising two cartridges for holding different liquid adhesive precursors therein and a port in fluid communication with the two cartridges, the mixer adapter (100) can be inserted into the port via the exposed ends (16A, 17A) of the first and second sleeves (16, 17).

13. A mixer-cartridge assembly, comprising:
a mixer;
a two-component composition cartridge including two cartridges for holding different liquid precursors therein and a port in fluid communication with the two cartridges; and
a mixer adapter according to claim 1, wherein the mixer is releasably coupled to a head of the mixer adapter and a base of the mixer adapter is releasably coupled to the two-component composition cartridge by inserting exposed ends of a first sleeve (16) and a second sleeve (17) of the mixer adapter (100), such that the mixer can be in fluid communication with the two cartridges.

14. The mixer-cartridge assembly according to claim 13, wherein the mixer is provided with a cap (80) and a tube (81) in fluid communication with the cap (80), when the mixer is coupled to the head, the cap (80) is sleeved onto the head, and a partition (90) of the mixer adapter (100) is housed in the cap (80).
